(19) United States
(12) Patent Application Publication
(10) Pub. No.: US 2014/0253599 A1
(43) Pub. Date: Sep. 11, 2014

(54) DISPLAY DATA GENERATING APPARATUS AND CONTROL METHOD FOR THE SAME

(71) Applicant: CANON KABUSHIKI KAISHA, Tokyo (JP)

(72) Inventor: Minoru Kusakabe, Yokohama-shi (JP)

(21) Appl. No.: 14/353,139

(22) PCT Filed: Dec. 21, 2012
(86) PCT No.: PCT/JP2012/008205

§ 371 Date: Apr. 21, 2014

(30) Foreign Application Priority Data
Dec. 26, 2011 (JP) 2011-283251

(51) Int. Cl. G06T 3/00; G06T 7/00; G06T 3/40

(52) U.S. Cl. CPC G06T 3/0012; G06T 3/40; G06T 7/0014
USPC 345/666

(57) ABSTRACT

Whether or not each of display regions other than a command target display region defined as the display region to which a command for changing the display state is directed is set as an interlock control target display region in which a change of the display state according to the changing command is to be applied in an interlocked manner with the change of the display state made to the command target display region. The change of the display state according to the changing command is applied to the interlock control target display region in an interlocked manner with the change of the display state of the display region to which the command is directed. Whether or not each display region is set as the interlock control target display region is determined based on the display magnification, information about the object, and information about the image data.

### TECHNICAL FIELD

The present invention relates to a display data generating apparatus and a control method for the same.

### BACKGROUND ART

There has been developed a method in which when a plurality of images are displayed side by side and a command of scrolling or changing the magnification is input, the command applied to the plurality of images are controlled in an interlocked manner. (see Patent Literature 1)

For example, in the system disclosed in Patent Literature 1, grouping of images is performed based on the presence/absence of a region of interest extracted by a user's designation or automatic detection. Then, a change of the display position or a change of the display magnification is applied in an interlocked manner to the images in a group.

### CITATION LIST

### Patent Literature

PTL 1: Japanese Patent Application Laid-Open No. 2009-86765

### SUMMARY OF INVENTION

### Technical Problem

In the system disclosed in Patent Literature 1, grouping of images for the interlock control of command contents is performed based on the presence/absence of a region of interest. Ways of designation of a region of interest disclosed in Patent Literature 1 include designation by the user and automatic detection. However, in the case where designation is performed based on automatic detection, it is necessary to provide hardware such as a dedicated circuit for detection and/or memory, leading to an increase in the cost in some cases. In addition, automatic detection may cause problems in circumstances where high reliability is required, because detection errors can occur in automatic detection. On the other hand, in the case where a designation is made by the user, if the user wishes to change the setting of the interlock control of command contents to a plurality of images, it is necessary for the user to make setting to each of the plurality of images, making efficient observation of the images difficult in some cases.

Furthermore, there may be a plurality of types of command being input during the observation of images, which include, typically, a command of shifting the display position and a command of changing the displayed magnification. In cases where a plurality of types of command are input, the interlock control of command contents for multiple images displayed side by side is performed with respect to each of the plurality of types of command. However, if setting concerning the interlock control of command contents is determined for each type of the command individually, it might be necessary for the user to perform the setting of the interlock control of command contents for each type of the command. This will make efficient image observation difficult in some cases. On the other hand, if setting of the interlock control of command contents is determined regardless of types of the command in an all-or-none manner for a plurality of types of command, undesired interlock control of command contents will be performed when interlock control of command contents for multiple images is desired to be performed only for one or not all of the types of command under a specific condition. This can cause inconveniences in image observation.

An object of the present invention is to perform, when a command for making a change to the display state of one of a plurality of images displayed side by side is entered by a user, control for applying the same change of the display state to other images in an interlocked manner in such a way as to allow the user to observe images with improved efficiency.

### Solution to Problem

According to one aspect of the present invention, there is provided a control method for display data generating apparatus comprising:

an image data obtaining step of obtaining image data of one or a plurality of images obtained by imaging an object;

a display data generating step of generating display data configured in such a way that images are displayed in a plurality of display regions side by side based on the image data;

a command obtaining step of obtaining a changing command, input by a user and directed to any one of the plurality of display regions, for changing the display state, including scrolling or changing the display magnification, of an image displayed in that displayed region;

an interlock control enabling/disabling determination step of determining whether or not each of the display regions other than a command target display region defined as the display region to which the command for changing the display state is directed is set as an interlock control target display region in which a change of the display state according to the changing command is to be applied to an image displayed therein in an interlocked manner with the change of the display state made to the image displayed in the command target display region; and

a display state changing step of applying the change of the display state according to the changing command to the image displayed in the command target display region and applying, in an interlocked manner, the change of the display state according to the changing command to the image displayed in the interlock control target display region,
wherein in the interlock control enabling/disabling determination step, it is determined whether or not each display region is set as the interlock control target display region based on at least one of the display magnification of the image displayed in each display region at the time when the changing command is obtained, information about the object of the image displayed in each display region, and information about the image data of the image displayed in each display region.

According to another aspect of the present invention, there is provided a computer program stored on a non-transitory computer readable medium that causes a computer to execute the following steps:

an image data obtaining step of obtaining image data of one or a plurality of images obtained by imaging an object;

a display data generating step of generating display data configured in such a way that images are displayed in a plurality of display regions side by side based on the image data;

a command obtaining step of obtaining a changing command, input by a user and directed to any one of the plurality of display regions, for changing the display state, including scrolling or changing the display magnification, of an image displayed in that displayed region;

an interlock control enabling/disabling determination step of determining whether or not each of the display regions other than a command target display region defined as the display region to which the command for changing the display state is directed is set as an interlock control target display region in which a change of the display state according to the changing command is to be applied to an image displayed therein in an interlocked manner with the change of the display state made to the image displayed in the command target display region; and

a display state changing step of applying the change of the display state according to the changing command to the image displayed in the command target display region and applying, in an interlocked manner, the change of the display state according to the changing command to the image displayed in the interlock control target display region,

wherein in the interlock control enabling/disabling determination step, it is determined whether or not each display region is set as the interlock control target display region based on at least one of the display magnification of the image displayed in each display region at the time when the changing command is obtained, information about the object of the image displayed in each display region, and information about the image data of the image displayed in each display region.

According to still another aspect of the present invention, there is provided a display data generating apparatus comprising:

an image data obtaining unit configured to obtain image data of one or a plurality of images obtained by imaging an object;

a display data generating unit configured to generate display data configured in such a way that images are displayed in a plurality of display regions side by side based on the image data;

a command obtaining unit configured to obtain a changing command, input by a user and directed to any one of the plurality of display regions, for changing the display state, including scrolling or changing the display magnification, of an image displayed in that displayed region;

an interlock control enabling/disabling determination unit configured to determine whether or not each of the display regions other than a command target display region defined as the display region to which the command for changing the display state is directed is set as an interlock control target display region in which a change of the display state according to the changing command is to be applied to an image displayed therein in an interlocked manner with the change of the display state made to the image displayed in the command target display region; and

a display state changing unit configured to apply the change of the display state according to the changing command to the image displayed in the command target display region and to apply, in an interlocked manner, the change of the display state according to the changing command to the image displayed in the interlock control target display region,

wherein the interlock control enabling/disabling determination unit determines whether or not each display region is set as the interlock control target display region based on at least one of the display magnification of the image displayed in each display region at the time when the changing command is obtained, information about the object of the image displayed in each display region, and information about the image data of the image displayed in each display region.

### Advantageous Effects of Invention

According to the present invention, when a command for making a change of the display state of one of a plurality of images displayed side by side is entered by a user, a control of applying the same change of the display state to other images in an interlocked manner can be performed in a mode that improves user's operation efficiency in image observation.

Further features of the present invention will become apparent from the following description of exemplary embodiments with reference to the attached drawings.

### BRIEF DESCRIPTION OF DRAWINGS

FIG. 1 is a diagram showing the configuration of a computer according to an embodiment.

FIG. 2 is a block diagram of the computer that executes the interlock command control according to the embodiment.

FIG. 3 shows exemplary slides to be imaged.

FIG. 4 is a functional block diagram of an interlock command control method according to a first embodiment.

FIG. 5 is a flow chart of the process of the interlock command control method according to the first embodiment.

FIG. 6 is a table showing conditions of interlock control and results of a determination as to whether interlock control is enabled or disabled according to the first embodiment.

FIG. 7 shows exemplary display screen images according to an embodiment.

FIG. 8 is a functional block diagram of an interlock command control method according to a second embodiment.

FIG. 9 is a flow chart of the process of the interlock command control method according to the second embodiment.

FIG. 10 is a table showing conditions of interlock control and results of a determination as to whether interlock control is enabled or disabled according to the second embodiment.

FIG. 11 is a table showing conditions of interlock control and results of a determination as to whether interlock control is enabled or disabled according to the second embodiment.

FIG. 12 is a functional block diagram of an interlock command control method according to a third embodiment.

FIG. 13 is a table showing conditions of interlock control and results of a determination as to whether interlock control is enabled or disabled according to the third embodiment.

### DESCRIPTION OF EMBODIMENTS

### First Embodiment

In the following, an embodiment of the present invention will be described with reference to the drawings.

In this specification, when a plurality of images are simultaneously displayed respectively in a plurality of drawing regions on a display, applying a change of the display state according to a command for changing the display state directed to an image in one drawing region to an image(s) in other drawing region(s) simultaneously will be referred to as interlock control. In some contexts, it will also be referred to as command interlocking. The present invention pertains to interlock control of display actions in a plurality of drawing regions.

In this embodiment, a case in which a microscope that picks up high-resolution still images is used as a specific exemplary imaging apparatus that picks up images will be described in the following. However, the apparatus or unit of picking up still images to which the present invention can be applied is not limited to the microscope.

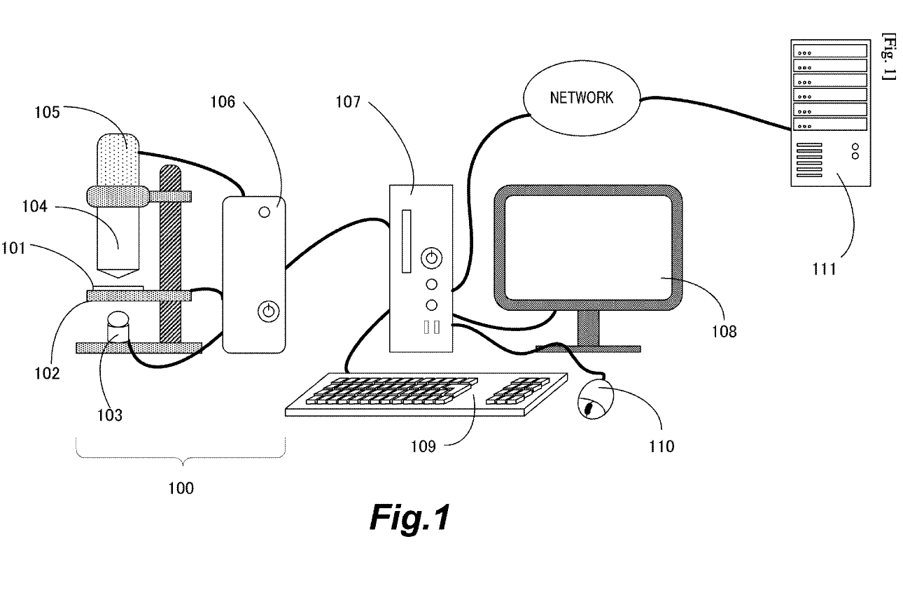

FIG. 1 shows the configuration of apparatuses in the embodiment. A microscope apparatus 100 is configured to be capable of picking up still images. A slide 101 on which a specimen as an object of imaging is placed is set on a stage 102. In the description of this embodiment, it is assumed here that the specimen is a transparent object. The position of the stage 102 can be shifted in a plane perpendicular to the optical axis of imaging. The stage 102 can be shifted also in the direction along the optical axis of imaging to change the focus position with respect to the direction of thickness of the object. The microscope apparatus 100 includes a light source 103 and an objective lens 104. The light source 103 supplies light to the objective lens 104 through the slide 101. The microscope apparatus 100 further includes an imaging unit 105, which picks up an image of the object formed through the objective lens 104. The microscope apparatus 100 further includes a controller 106 that controls the operation of the stage 102, the light source 103, and the imaging unit 105 etc. The objective lens 104 has a plurality of lenses that can be switched. Alternatively, the objective lens 104 may have a zoom mechanism. In this connection, it is preferred that switching between the lenses or control of zooming in the objective lens 104 be performed by the controller 106. A terminal (computer) 107 is configured to transmit operation commands to the microscope apparatus 100 and receive picked-up image data. The function of the controller 106 may be implemented in the terminal 107.

There is also provided a display 108, which displays a screen (GUI) for assisting user's operation in entering operation commands for the microscope apparatus 100, images based on picked-up image, and image information. A keyboard 109 and a mouse 110 are connected to the terminal 107. The keyboard 109 and the mouse 110 allow the user to enter operation commands for the terminal 107 and the microscope apparatus 100. A server 111 is connected with the terminal 107 via a network. Image data picked up by the microscope apparatus 100 is stored in the server 111. The server 111 may be directly connected with the microscope apparatus 100 via a network. In this case, picked-up image data is stored directly in the server 111 (not through the terminal 107).

In this embodiment, the display data generating method according to the present invention is executed in the terminal 107 and a display screen image is displayed on the display 108. The terminal 107 constitutes an example of the display data generating apparatus according to the present invention. However, the microscope apparatus 100 may be configured to have a display and a component such as a button that allows the user to enter commands in addition to the above-mentioned components. When this is the case, the image display method according to the present invention is implemented in the controller 106.

Although in this embodiment, it is assumed that the specimen is a transparent object placed on the slide 101, the present invention is not limited by this feature.

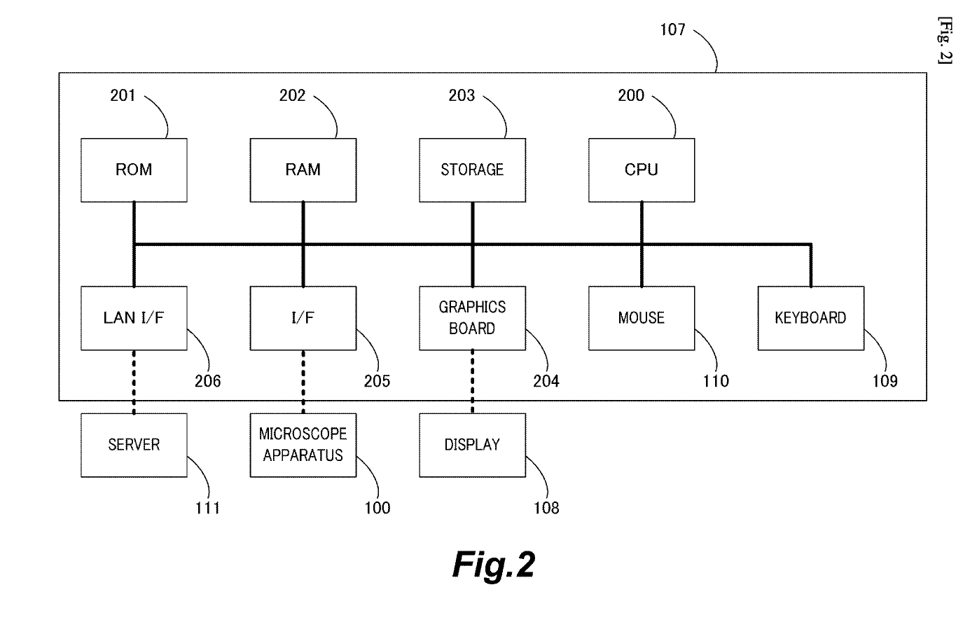

FIG. 2 shows the internal configuration of the terminal 107 that executes the image display method according to this embodiment and the relation between the terminal 107 and external devices. The terminal 107 has a CPU 200, ROM 201, RAM 202, storage 203, graphics board 204, interface 205, and LAN interface 206. The CPU 200 executes computation necessary for processing. The ROM 201 stores programs and data. The programs and data stored in the ROM 201 can be read out. Data needed by programs and processing can be written/read into/from the RAM 202. Programs and image data can be written/read into/from the storage 203. The storage 203 may be an HDD or SSD. The graphics board 204 generates drawing data used in image display. The interface 205 transmits and receives data, when the terminal 107 communicates with the microscope apparatus 100, which is one of the external devices. The LAN interface 206 transmits and receives data, when the terminal 107 communicates with the server 111 connected with the terminal 107 through the network.

The embodiment of the present invention described in the following is implemented by a program executed by the CPU 200.

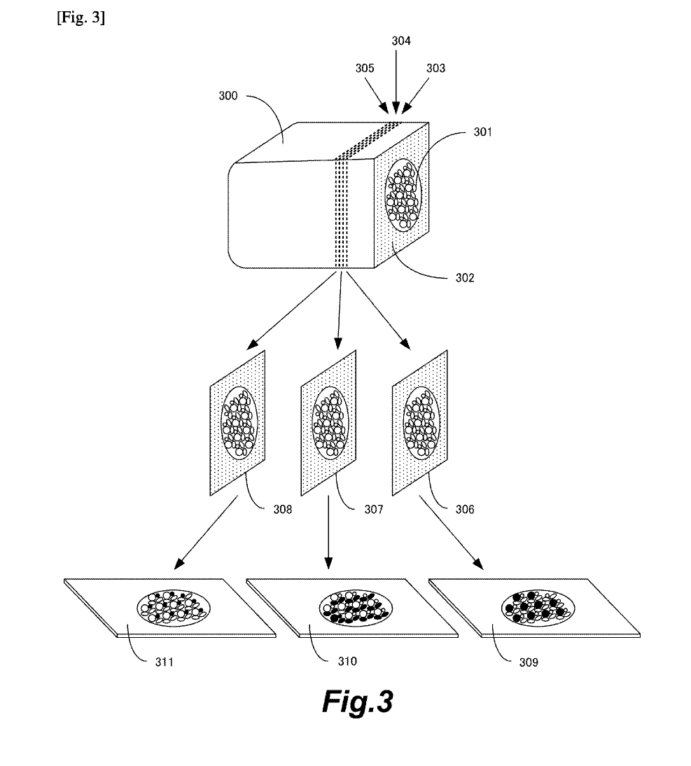

FIG. 3 shows examples of the slide 101 as an object of imaging in this embodiment. The exemplary slides shown in FIG. 3 are prepared for tissue cell diagnosis to be used in pathological diagnosis. In the following description made with reference to FIG. 3 is directed only to the process of making slides relevant to the embodiment, and irrelevant process will not be described. In a paraffin block 300, a sample to be examined 301 cut out by an operation is embedded in paraffin 302 so that the sample to be examined 301 can be sliced. In the case of slides made for pathological diagnosis, a specimen to be placed on a slide glass is sliced off typically in such a way as to have an appropriately small thickness relative to the thickness of a cell. Consequently, specimens sliced off consecutively can be considered to show cross sections of substantially the same cells. Specimens 306 to 308 shown in FIG. 3 are specimens made by slicing the paraffin block 300 at consecutive slice positions 303 to 305. Slides 309 to 311 are made respectively by removing paraffin from the specimens 306 to 308, placing them on slide glasses, adding different stains or fluorescent agents, and placing cover glasses. By observing enlarged and reduced images of the specimens on the slides 309 to 311, various information useful for diagnosis can be obtained. Moreover, by observing substantially the same cells in a comparative manner using slides 309 to 311 processed with different stains or different types of fluorescence as shown in FIG. 3, different kinds of information useful for diagnosis can be obtained. As described above, comparative observation of enlarged and reduced images of a specimen at various positions in a slide and comparative observation of slides made by different processes are significant in obtaining information useful for pathological diagnosis. The embodiment described here is intended to make operations performed by the user during the above-described comparative observations easier.

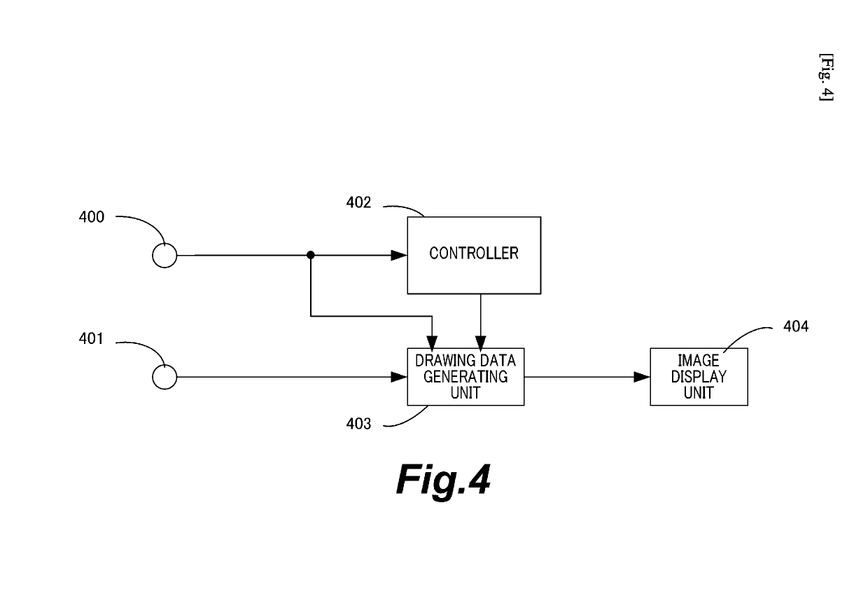

FIG. 4 is a functional block diagram illustrating an image display method in this embodiment. A command input terminal 400 is a terminal to which commands concerning display are input by operations by the user. Specifically, commands concerning image display such as commands for changing the display position and commands for changing the display magnification are input by operations performed by the user through the keyboard 109 and/or the mouse 110. An image input terminal 401 is a terminal to which image data for image display is input. A controller 402 performs control of determining whether or not an input command concerning a change of the display state of an image is to be applied in an interlocked manner to a plurality of images displayed side by side. The controller 402 stores information about the initial display magnification gained from commands input through the command input terminal 400. The information about the initial display magnification stored by the controller 402 is information about the display magnification at the time of completion of the initial display after adjustment of the display position and the display magnification has been completed. The controller 402 determines whether or not the command concerning the image display is to be applied to the plurality of images displayed side by side based on the information about the initial display magnifications of the respective images. A drawing data generating unit 403 generates drawing data to be output to an image display unit 404 based on the command input through the command input terminal 400 and a control signal input from the controller 402. The display unit 404 displays an image based on the drawing data generated by the drawing data generating unit 403. The present invention pertains to a control for applying a command directed to any one of a plurality of images displayed side by side also to other images. The drawing data generating unit 403 generates drawing data for each of the plurality of images and display data with which a plurality of images are displayed side by side based on the drawing data. The image display unit 404 performs image display based on the display data to display the plurality of images side by side.

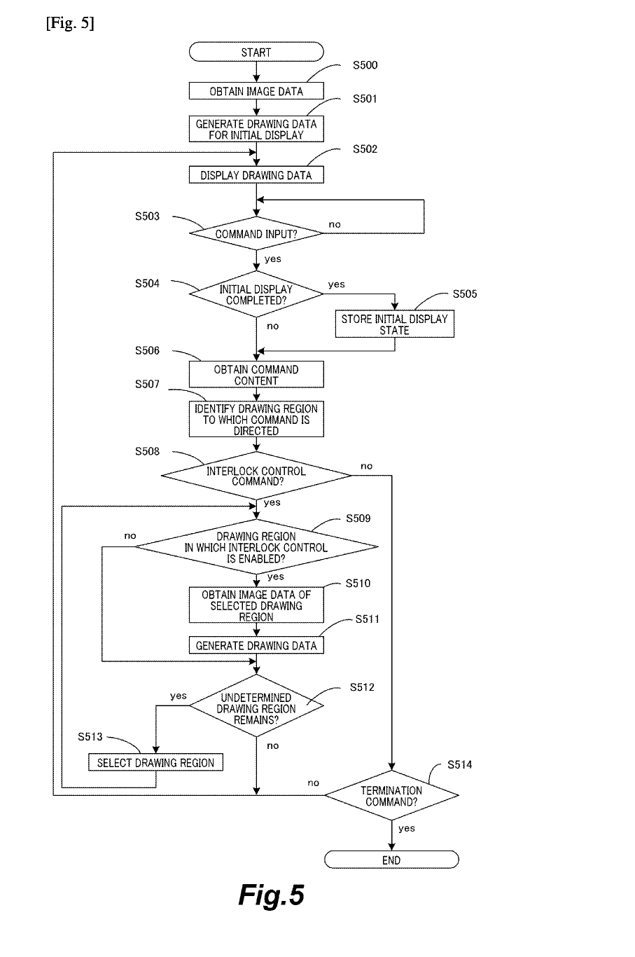

FIG. 5 is a flow chart of an image display process in this embodiment. As the process is started, initial image display is performed first. Specifically, image data for display is obtained in step S500 (image data obtaining step), and drawing data for initial display to be used in image display based on image data is generated in step S501. The drawing data for initial display is drawing data used to perform initial image display, which will be described later. The drawing data for initial display is, for example, drawing data with which one or plurality of images are displayed based on the image data at a default display magnification and default display positions. The image data obtained in step S500 may be either image data of one image or image data of a plurality of images. In step S501, drawing data of a plurality of images may be generated from image data of one image. The process of obtaining image data in step S500 or the process of generating drawing data in step S501 may be performed either following a predetermined procedure or based on instructions made by a user's operation requesting obtainment of image data or generation of drawing data.

After completion of the generation of drawing data for initial display, the process proceeds to step S502. In step S502, display data for displaying images side by side using the drawing data of the plurality of images generated in step S501 is generated.

In step S503, a determination is made as to whether or not an operation of entering a command concerning a change of the display state is performed by the user. If it is determined that a command is not entered, the checking step of S503 is executed repeatedly until a command is entered. If it is determined in step S503 that a command is entered, a determination is made in step S504 as to whether the initial display is completed or not. The state in which the initial display is completed refers to the state in which adjustment of the display state including the display magnification and the display position has been completed for all of the plurality of images displayed side by side. In cases where the adjustment of the initial display state is performed by the user, the completion of the initial display may be determined by a user's operation. In cases where the adjustment of the initial display state is performed automatically by an image display program, the image display program may be configured to hold information (such as a flag) indicating the completion of the initial display, and the completion of the initial display may be determined by referring to this information. If the initial display is completed, information about the initial display state such as the display magnification is stored in step S505. In cases where the initial display is performed automatically and the adjustment for the initial display is performed in step S501, steps S504 and S505 may be eliminated. If it is determined in step S504 that the initial display is not completed or the processing of step S505 is completed, the process proceeds to step S506 (command obtaining step), where the content of the command that is determined to be entered by the user's operation in step S503 is obtained. The command content obtained in step S506 includes information identifying an image to which the command is directed (or a target image) and information about a change of the display state. Then in step S507, a drawing region to which the command for changing the display state is directed (or a command target display region) is identified based on the information identifying the target image of the command. In step S508, a determination is made according to a later-described method as to whether or not the type of the command obtained in step S506 is a type of command for which switching between whether interlock control of change of the display state of other images that are displayed side by side according to said command is enabled or disabled. Such command types include, for example, scroll and a change of the display magnification. Such command types will be hereinafter referred to as “interlock control command”.

If it is determined in step S508 that the command type obtained in step S506 is an interlock control command, the process proceeds to step S509. In step S509 (interlock control enabling/disabling determination step), a determination is made as to whether or not the drawing region selected as the target of the determination is a drawing region to which the command is to be applied in an interlocked manner (an interlock control target display region). How the determination is made in this step will be described later. If it is determined that the drawing region selected as the target of the determination is an interlock control target drawing region, the process proceeds to step S510. In step S509, the drawing region that is determined to be the drawing region to which the command is directed in step S507 is always determined to be an interlock control target drawing region. Therefore, the drawing regions selected as the targets of the determination in step S509 may be limited to the drawing regions other than the drawing region to which the command is directed (or the display regions other than the display region to which the command is directed). In step S510, image data drawn in the selected drawing region is obtained. In step S511 (display state changing step), drawing data is generated based on the command obtained in step S506. Then, the process proceeds to step S512. If it is determined in step S509 that the drawing region is not an interlock control target drawing region, the process also proceeds to step S512. In step S512, a determination is made as to whether or not there remains a drawing region for which the determination as to whether or not it is an interlock control target drawing region has not been made. If there remains such a drawing region, the process proceeds to step S513. In step S513, another drawing region different from the presently selected drawing region for which the determination as to whether or not it is an interlock control target drawing region has not been made yet is selected. On the other hand, if it is determined in step S512 that there is not drawing region for which the determination has not been made, the process proceeds to step S502, where image display is performed using newly generated drawing data.

On the other hand, if it is determined in step S508 that the command type obtained in step S506 is not an interlock control command, a further determination is made in step S514 as to whether or not the command content is a termination command. If the command content is not a termination command, processing not shown in the drawing is executed according to the command content, and then the process proceeds to step S502. On the other hand, if it is determined in step S514 that the command content is a termination command, the process is terminated.

Next, how the determination as to whether or not the selected drawing region is a drawing region to which the command is to be applied in an interlocked manner is made in step S509 will be described specifically. The process of step S509 is executed in the controller 402 shown in FIG. 4. As described above, the initial display magnification in each drawing region is stored in the controller 402 in step S505, and the determination as to the interlock control in step S509 is made based on the initial display magnification in the drawing region.

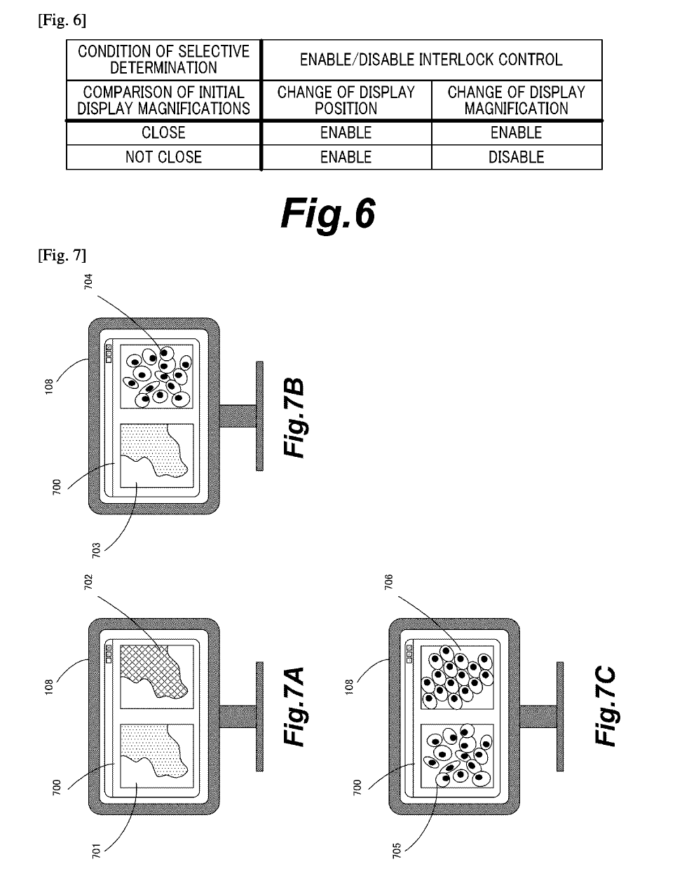

FIG. 6 shows criteria for determination of the interlock control command in step S508 and criteria for determination in step S509. In addition, FIG. 6 also shows the results of the determination as to whether or not the commands are to be applied in an interlocked manner. The interlock control commands include a change of the display position and a change of the display magnification. The determination in step S509 is made based on the relationship between the initial display magnification of the drawing region for which the determination is made and the initial display magnification of the drawing region identified in step S507 as the drawing region to which the command is directed. If the initial display magnification of the drawing region for which the determination is made is close to the initial display magnification of the drawing region to which the command is directed, a change of the display position and a change of the display magnification are applied in an interlocked manner. On the other hand, if the initial display magnification of the drawing region for which the determination is made is not close to the initial display magnification of the drawing region to which the command is directed, a change of the display position is applied in an interlocked manner, but a change of the display magnification is not applied in an interlocked manner. The determination as to whether or not the two initial display magnifications are close may be made based on whether or not the ratio of the initial display magnification B of the drawing region for which the determination in step S509 is made and the initial display magnification A of the drawing region to which the command is directed falls within a range defined by two threshold values Th1 and Th2, one of which is smaller than 1 (one) and the other is larger than 1 (one). Specifically, if the inequality “Th1<B/A<Th2” (where Th1<1<Th2) holds, it is determined that the initial display magnifications are close, and if the inequality “Th1<B/A<Th2” does not hold, it is determined that the initial display magnifications are not close. This determination is equivalent to a determination as to whether or not the initial magnification A of the drawing region to which the command is directed and the initial magnification B of the drawing region for which the determination in step S509 is made are equal to each other or the difference between the initial display magnification A of the drawing region to which the command is directed and the initial display magnification B of the drawing region for which the determination in step S509 is made is smaller than a threshold value (|A−B|<Th3). The aforementioned threshold values may be either predetermined values or values set by the user. Alternatively, it may be determined that the two initial display magnifications are close only if the two initial display magnifications are identical without referring to the aforementioned two threshold values. In other words, if “B/A=1” holds, it may be determined that the two initial display magnifications are close, and if “B/A=1” does not hold, it may be determined that the two initial display magnifications are not close.

In the following, an illustrative processing of the determination of step S509 according to the criteria for determination shown in FIG. 6 will be described using exemplary images displayed on the screen. FIGS. 7A to 7C show exemplary display screen images to which the criteria for determination in FIG. 6 are applied.

FIG. 7A shows an exemplary display screen image, for which it is determined according to the criteria for determination in FIG. 6 that the initial display magnifications are close. This display screen image is displayed when specimens in a plurality of slides prepared in different ways are observed in comparison with each other. When such observation is performed, slides prepared using two or more pieces of specimen made by consecutive slicing of a sample to be examined are used. The screen in FIG. 7A shows a display area (window) 700 of an image produced by an application for image observation (viewer software). In this display area, there are plurality of drawing regions in which a plurality of images can be displayed. The drawing regions include a first drawing region 701 and a second drawing region 702. In the first drawing region 701 and the second drawing region 702, images obtained by picking up images of slides prepared in different ways as described before with reference to FIG. 3 are displayed. The display magnifications and the positions of the displayed portions in the specimens (displayed positions) have been adjusted to be made substantially the same among the two images beforehand (namely, the initial display has been completed). It is assumed here that an operation of entering a command for changing the display position (i.e. shifting the display position) of the image displayed in the first drawing region 701 is performed by the user in this state. This operation may be, for example, dragging the mouse in the first drawing region 701, shifting a scroll bar, or a pressing down a cursor key on the keyboard. According to the criteria for determination in FIG. 6, a change in the display position made to one drawing region is applied in an interlocked manner to the other drawing region, without regard to whether the initial display magnifications thereof are close to each other or not. Therefore, in the illustrative case shown in FIG. 7A, display control is performed in such a way that the display positions is changed in an interlocked manner in both the first drawing region 701 and the second drawing region 702. If a change of the display position is applied in an interlocked manner to the drawing regions, it is preferred that the direction and the amount of shift of the display position be identical among the interlock control target drawing regions. However, in cases where the interlock control target drawing regions have initial display magnifications different from each other, it is preferred that the amounts of shift in the respective drawing regions be varied in accordance with the initial display magnifications so that areas corresponding to each other remain to be displayed in the respective drawing regions. Furthermore, in cases where there is a positional difference with respect to the rotational direction between the displayed images, the direction of shift may be varied taking into consideration the positional difference with respect to the rotational direction. This enables areas corresponding to each other to remain to be displayed in the respective drawing regions when a change of the display position is applied in an interlocked manner to the drawing regions, even in cases where there is a difference in the size and/or the rotational position of the specimen in the displayed images between the interlock control target drawing regions.

It is assumed here that an operation of entering a command for changing the display magnification of the image in the first drawing region 701 is performed by the user in the state shown in FIG. 7A. This operation may be, for example, turning the wheel of the mouse with the mouse cursor being placed over the first drawing region 701 or pressing down a key assigned to the enlarge/reduce command on the keyboard. According to the criteria for determination in FIG. 6, a change in the display magnification made to one drawing region is applied in an interlocked manner to other drawing regions of which the initial display magnification is close to that of the drawing region to which the command is directed and not applied in an interlocked manner to other drawing regions of which the initial display magnification is not close to that of the drawing region to which the command is directed. Thus, in the illustrative case in FIG. 7A, display control is performed in such a way that the display magnification is changed in an interlocked manner in the first drawing region 701 and the second drawing region 702. If a change of the display position is applied in an interlocked manner to the drawing regions, it is preferred that the degree of change in the magnification be identical among the interlock control target drawing regions. However, in cases where the interlock control target drawing regions have initial display magnifications different from each other, it is preferred that the degrees of change in the magnification in the respective drawing regions be varied in accordance with a difference in the initial display magnifications. This enables the images in the interlock control target drawing regions to be displayed with substantially the same degree of apparent change, even if a change of the display magnification is performed repeatedly.

On the other hand, FIG. 7B shows a case in which while the positions of the images displayed in the two drawing regions (displayed positions) in the specimen are substantially the same, the areas of the displayed portions are different due to a difference in the display magnification. A first drawing region 703 and a second drawing region 704 are shown in FIG. 7B. The display screen image shown in FIG. 7B is displayed when, for example, the same site of the specimen in an image obtained by imaging a slide is observed at different magnifications. What is displayed in the second drawing region 704 is an enlarged image of a portion of the specimen corresponding to the image displayed in the first drawing region 703. The display magnification of the image displayed in the second drawing region 704 is higher than the display magnification of the image displayed in the first drawing region 703. It is assumed here that an operation of entering a command for changing the display position is performed by the user to the image in the second drawing region 704. According to the criteria for determination in FIG. 6, a change in the display position made to one drawing region is applied in an interlocked manner to the other drawing region, without regard to whether the initial display magnifications thereof are close to each other or not. Therefore, in the illustrative case shown in FIG. 7B, display control is performed in such a way that the display positions is changed in an interlocked manner in both the first drawing region 703 and the second drawing region 704. In the case shown in FIG. 7B, since the display magnification is different between the interlock control target drawing regions, it is preferred that the amount of shift be varied in accordance with a difference in the display magnification between the interlock control target drawing regions and that the direction of shift be varied in accordance with a difference in the rotational position, as described in the description of the case shown in FIG. 7A. In the case shown in FIG. 7B, a difference between the display magnifications of the images displayed side by side is particularly large. Therefore, it is advantageous to vary the amount of shift in accordance with the display magnification, thereby keeping the correspondence between the positions in the specimen of the portions displayed as the images even when the display position is changed by a user's operation. A change (or shift) of the displayed position may not be applied in an interlocked manner to a drawing region in which an image showing the specimen in its entirety is displayed. When this is the case, a change of the display position is applied in an interlocked manner only to drawing regions in which images of portions of the specimen are displayed.

It is also assumed here that an operation of entering a command for changing the display magnification of the image in the drawing region 704 is performed by the user in the state shown in FIG. 7B. According to the criteria for determination in FIG. 6, a change in the display magnification made to one drawing region is applied in an interlocked manner to other drawing regions of which the initial display magnification is close to that of the drawing region to which the command is directed and not applied in an interlocked manner to other drawing regions of which the initial display magnification is not close to that of the drawing region to which the command is directed. Thus, in the illustrative case in FIG. 7B, the display magnification is changed only in the second drawing region 704.

The interlock control of display action in this embodiment is performed after the initial display has been completed. Therefore, it is desirable in some cases that the interlock control of display action be not executed until the completion of the initial display. When features of different portions of the same image are observed in a comparative manner, there may be cases where comparisons are performed for various combinations of portions, e.g. a comparison of portion A and portion B, a comparison of portion A and portion C, and a comparison of portion A and portion D. In such observation, after the completion of the initial display for the first observation, observation is performed while performing interlock control of display action as described above. Thereafter, the initial display for the next observation is completed, and observation is performed again while performing the interlock control of display action. In the case where observation is performed in this way, if a determination as to whether or not the interlock control of display action is to be performed is determined in accordance with whether or not the initial display is completed, it is necessary to perform the initial display for the next observation again after the first observation is over and before the next observation starts. In view of this, the viewer application may be configured to have an operation mode in which the interlock control of display action is performed and an operation mode in which it is not performed that can be set selectively so that whether or not the interlock control of display action is to be performed can be selected independently from whether or not the initial display is completed. Furthermore, in order to improve the distinction between whether or not the interlock control of display action is enabled, at least one of a display indicating that the interlock control of display action is enabled and a display indicating that the interlock control of display action is disabled may be performed. The above-described configuration in which the execution of the interlock control of display action can be selected by switching the operation mode enables excellent operations when comparative observations of different portions in the same image are performed successively.

While in the exemplary display screen images shown in FIGS. 7A to 7C, the number of displayed images is two, the number of images in the method according to the present invention is not limited to two. For example, three or more images may be displayed side by side and a change of the display position or the display magnification may be applied in an interlocked manner only to the images that meets the criteria for determination in FIG. 6.

As described above, display action is controlled in an interlocked manner based on the result of comparison of the initial display magnifications of images displayed side by side. Therefore, it is not necessary for the user to enter a command concerning display action for each of a plurality of images to be compared on an image-by-image basis. In consequence, the number of commands the user needs to enter for image observation can be reduced, whereby user's operation efficiency in observation can be improved.

### Second Embodiment

In the case described in the first embodiment, interlock control of a command for changing the display position and a command for changing the display magnification to a plurality of images displayed side by side is performed based on the initial display magnification. In the second embodiment, a case where interlock control of a command for changing the display position and a command for changing the display magnification is performed based on information relevant to displayed images will be described.

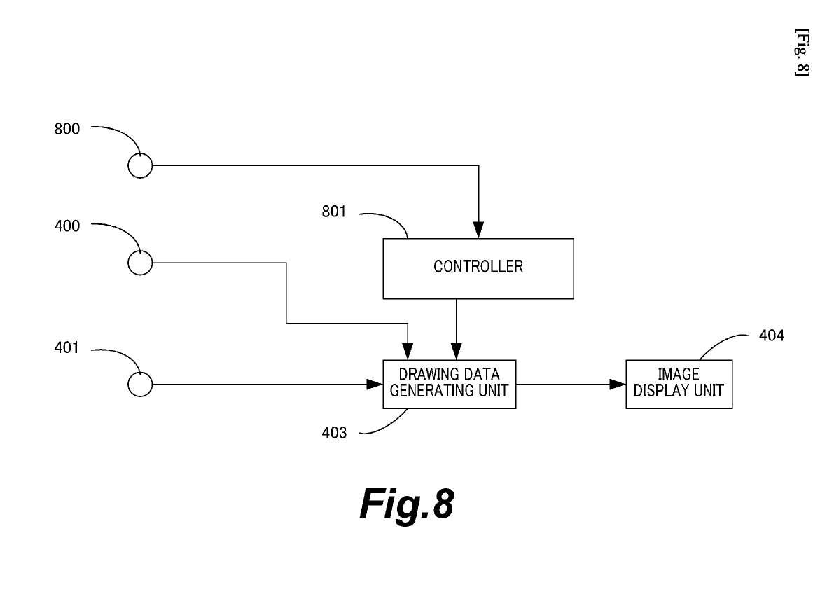

FIG. 8 is a functional block diagram of an image display method according to the second embodiment. Blocks that are the same as those in the block diagram in FIG. 4 according to the first embodiment are denoted by the same reference numeral and will not be described further.

In FIG. 8, a relevant information input terminal 800 is a terminal to which information relevant to images to be displayed in the image display unit 404 is input. A controller 801 differs from the controller 402 in FIG. 4 in that interlock control of a command for changing the display state is performed based on relevant information input through the relevant information input terminal 800.

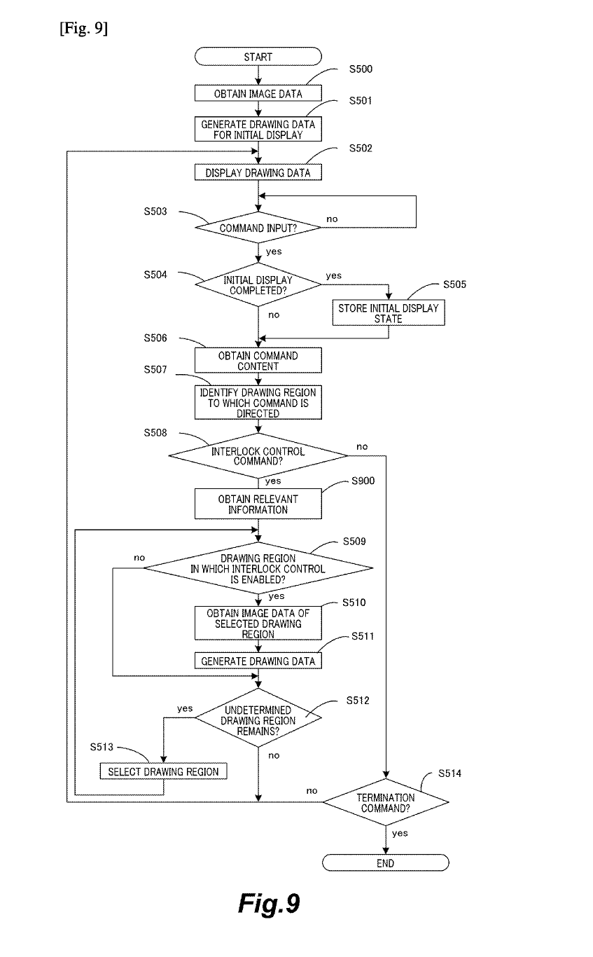

FIG. 9 is a flow chart of an image display process in this embodiment. Steps that are the same as those in the flow chart of the first embodiment in FIG. 5 are denoted by the same step numbers and will not be described in further detail.

As the process shown in FIG. 9 is started, the process proceeds in the manner same as that described in the description made with reference to FIG. 5 in the first embodiment. If it is determined in step S508 that the type of command entered in step S503 is an interlock control command, the process proceeds to step S900. In step S900, relevant information of the image drawn in the drawing region selected in step S507 or S513 as the drawing region for which the determination in step S509 is to be performed is obtained, and then, the process proceeds to step S509. Then, the processing of step S509 and the subsequent steps is executed in the manner same as that described with FIG. 5 in first embodiment except that the details of the determination made in step S509 is different from the first embodiment. As described above, interlock control of a command for changing the display state to images is not performed based on the initial display magnifications in this embodiment unlike with the first embodiment. Therefore, the storing of the initial display magnification in step S505 may be eliminated.

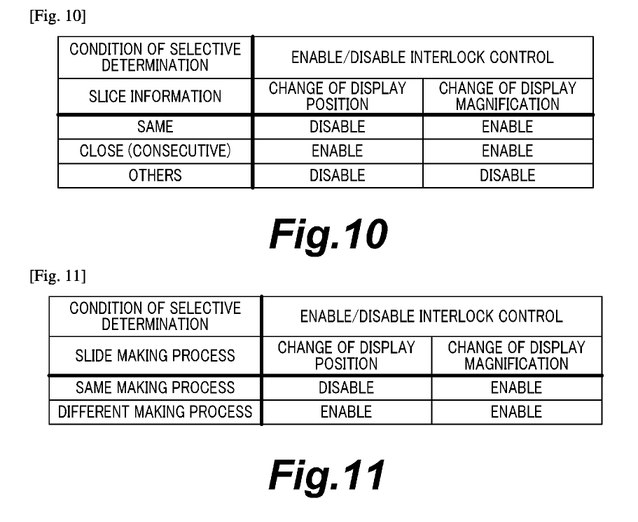

FIG. 10 shows criteria for determination of the interlock control command in step S508 and the criteria for the determination in step S509 in this embodiment. In addition, FIG. 10 also shows the results of the determination as to whether or not the interlock control of the commands is performed. In the case shown in FIG. 10, the relevant information input in step S900 is information about the slice position 303, 304, 305 in the paraffin block 300 at which the specimen shown in the displayed image was sliced off. This information will be hereinafter referred to as the slice information. In FIG. 10, the “SAME” slice information means that the specimens shown respectively in a plurality of images displayed side by side were sliced off from the paraffin block 300 at the same slice position. In this case, a command for changing the display position is not applied in an interlocked manner, but a command for changing the display magnification is applied in an interlocked manner. In FIG. 10, “CLOSE” slice information means that the specimens shown respectively in a plurality of images displayed side by side were sliced off from the paraffin block 300 at consecutive slice positions. For example, in FIG. 3, which shows consecutive slice positions 303 to 305, the slice positions 303 and 304, the slice positions 304 and 305, and the slice positions 303, 304, and 305 are determined to be two or three “close” slice positions. If the slice information is “close”, a change of the display position and a change of the display magnification are both applied in an interlocked manner. If the slice information is something other than those described above, neither a change of the display position nor a change of the display magnification is applied in an interlocked manner

In the following, an exemplary process of determination in step S509 according to the criteria for determination shown in FIG. 10 will be described using an exemplary display screen image. FIG. 7C shows an exemplary display screen image to which the control according to this embodiment is applied.

FIG. 7C shows an exemplary display screen image, for which it is determined according to the criteria for determination in FIG. 10 that the slice information is the “same”. This display screen image is displayed when cells in different sites of the same specimen are observed in comparison with each other at the same magnification. There are a first drawing region 705 and a second drawing region 706. When two different sites of the same specimen are displayed at the same magnification, one of the displayed images serves as a reference image for comparison in many cases. In the following description, it is assumed that the reference image is displayed in the second drawing region 706, and an image to be observed in comparison with the reference image is displayed in the first drawing region 705. When observing other cells by changing the display position in the image, the user enters a command for shifting display position for the first drawing region 705. If the display position in the second drawing region 706 shifts in an interlocked manner by this command, the portion of the specimen displayed in the reference image may go out of frame to disappear. Therefore, a command for shifting the display position is not applied in an interlocked manner in this case. On the other hand, there is a case where the user wishes to change the display magnification of the image displayed in the first drawing region 705 while observing. In this case, it is preferred for the purpose of comparison that the display magnification of the reference image be made equal to the display magnification of the image to be observed. Therefore, the display magnification of the first drawing region 705 and the display magnification of the second drawing region 706 are changed in an interlocked manner

An example of the case where it is determined that the slice information is “close” is a case where specimens in a plurality of slides prepared in different ways using specimens sliced off at positions close to each other in the paraffin block 300 are observed in comparison with each other. FIG. 7A shows an exemplary display screen image in such a case. In this case, it is determined according to the criteria for determination in FIG. 10 that a change of the display position and a change of the display magnification are both applied in an interlocked manner. In cases where slice information is something other than those described above in the criteria for determination in FIG. 10, it may be considered that images having low correlation in terms of interlock control of display action are displayed side by side, and neither a change of the display position nor a change of the display magnification is applied in an interlocked manner

In the foregoing, there has been described a case where a determination as to whether or not images displayed side by side show different portions in the same image is made based on information concerning the process of making the specimen or slide (i.e. relevant information of the image or slice information). However, the way of determining whether or not the images are portions of the same image is not limited to this. For example, there may be cases where a display application internally stores the identification information (ID) of image files and management information such as a pointer indicating the image data storage area, as management information of the displayed image. Then, it is possible to determine whether or not the images displayed side by side are derived from the same image by determining whether or not the images displayed side by side have the same management information. In such cases, management information of the displayed images that the display application stores or can refer to may be used as the aforementioned relevant information obtained in step S900.

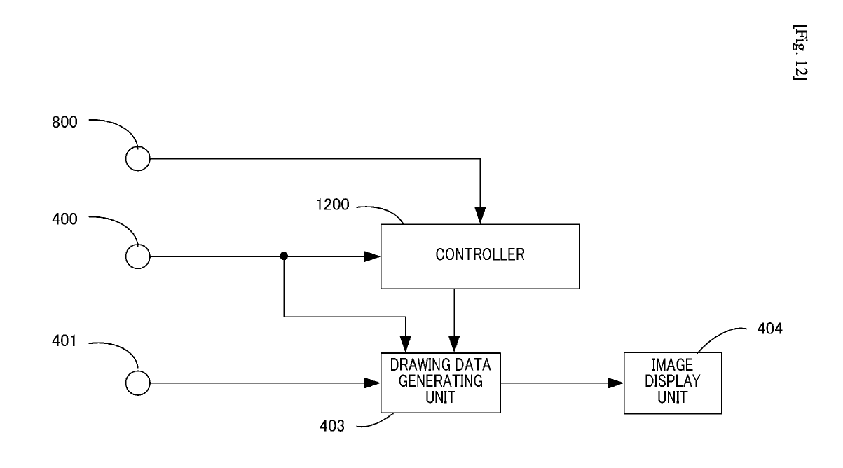

In this embodiment, a method of interlock control of display action based on information relevant to images displayed side by side has been described. In the above-description, the slice information and image management information that the display application stores or can refer to have been described as examples of the relevant information. But the relevant information that can be used in the present invention is not limited to them. In the description of the process of making slides in FIG. 3, addition of stains or fluorescent agents for facilitating the observation of the specimens have been described. The interlock control of display action may be performed using information about the process of making the slide. For example, if the slide making process is the “SAME” as shown in FIG. 11, it may be considered that comparison with a reference image having characteristics that appear in a similar manner depending on the making process is performed, and therefore, the determination is made in the manner same as the case where the slice information is the “SAME” in FIG. 10. Specifically, a change of the display position is not applied in an interlocked manner, but a change of the display magnification is applied in an interlocked manner. On the other hand, if the slide making process is “DIFFERENT” in FIG. 11, it may be considered that results of different stains or the like applied to the same site of the specimen are observed in comparison with each other, and therefore the determination is made in the manner same as the case where the slice information is “CLOSE” in FIG. 10. Specifically, a change of the display position and a change of the display magnification are both applied in an interlocked manner.

The interlock control of display action may be performed based on other information concerning the slide making process or method. Besides the process of making a slide for tissue cell observation described with reference to FIG. 3, there are other processes of making a slide. For example, there is a process of making a slide for cell diagnosis with which cells flowing into body fluid is observed. In the process of making a slide for cell diagnosis, what is placed on a slide glass is not sliced specimen, but sampled cells are placed on a slide glass without being sliced. If the method or process of making the slides or the intended purposes of the slides are different, it may be determined that images that are irrelevant to each other in terms of interlock control of display action are displayed, and therefore interlock control is not performed as with the case where the slice information is “OTHERS” in FIG. 10

The slice information or the slide making information is information concerning an object at the time of imaging, which is determined at the time of obtaining the image data at the same time when the object is determined. Such information as determined at the time of obtaining image data will be hereinafter collectively referred to as “object-related information”. In the embodiment described in the foregoing, whether or not an interlock control of command for display action is to be performed is switched based on the information relevant to the displayed images, namely object-related information or image management information stored in the display application. The relevant information is not limited to information described above, but other information may be used on condition that the information provides an effective condition for selectively determining whether or not an interlock control of command is to be performed.

Whether interlock control is enabled or disabled can be determined based on various combinations of information besides that described above in accordance with actually performed operations. For example, the display screen image shown in FIG. 7C is referred to as an exemplary display screen image in which it is determined that the slice information is the “SAME” in FIG. 10. The display screen image shown in FIG. 7B can also be an exemplary display screen image in which it is determined that the slice information is the “SAME” in FIG. 10. In the display screen image shown in FIG. 7B, it is preferred that a change of the display position be applied in an interlocked manner and a change of the display magnification be not applied in an interlocked manner, as with enabling/disabling of interlock control in the case where the initial display magnifications are not close according to the criteria for determination in FIG. 6. In other words, interlock control of display action may be performed according to the principle of determination that if the slice information is the “same” and the initial display magnifications are “not close”, a change of the display position is applied in an interlocked manner but a change of the display magnification is not applied in an interlocked manner.

Whether the interlock control of display action according to this embodiment is to be performed or not may be switched according to the operation mode setting, in the same manner as in the first embodiment. In the case where the specimen is the same (namely the slice information is the same), there may be a case where the same site of the same specimen is observed at different display magnifications not close to each other as described in the first embodiment, besides the case described in this second embodiment where different sites of the same specimen are observed at the same display magnification. In the former case, it is preferred that the interlock control in the case where the initial display magnifications are not close in the first embodiment (i.e. a change in the display position is applied in an interlocked manner, and a change in the display magnification is not applied in an interlocked manner) be performed rather than the interlock control in the case where the slice information is the same in the second embodiment (i.e. a change in the display position is not applied in an interlocked manner, and a change in the display magnification is applied in an interlocked manner). Therefore, there may be provided an operation mode in which the interlock control is performed and an operation mode in which it is not performed described in the first embodiment, and further an operation mode in which interlock control is switched according to the slice information described in the second embodiment in such a way that these three operation modes can be selectively set.

As described above, interlock control of display action is performed based on information relevant to images displayed side by side. Therefore, it is not necessary for the user to enter a command concerning display action for each of a plurality of images to be compared on an image-by-image basis. In consequence, the number of commands the user needs to enter for image observation can be reduced, whereby user's operation efficiency in observation can be improved.

### Third Embodiment

In the cases described in the first and second embodiments, interlock control of a command for changing the display position and a command for changing the display magnification is performed based on the initial display magnification or information relevant to displayed images. In the third embodiment, a case where interlock control of a command for changing the display position and a command for changing the display magnification is performed based on a combination of the initial display magnification and information relevant to displayed images will be described.

FIG. 12 is a functional block diagram of an image display method according to the third embodiment. Blocks that are the same as those in the block diagram in FIGS. 4 and 8 according to the first and second embodiments are denoted by the same reference numeral and will not be described further.

A controller 1200 in FIG. 12 differs from the controller in the first and second embodiments in that it performs interlock control of display action based on both relevant information input through the relevant information input terminal 800 and information about the initial display magnification input through the command input terminal 400.

The flow chart in FIG. 9 referred to in the description of the second embodiment also applies to the process in this embodiment, but details of the determination made in step S509 in this embodiment is different from that in the second embodiment.

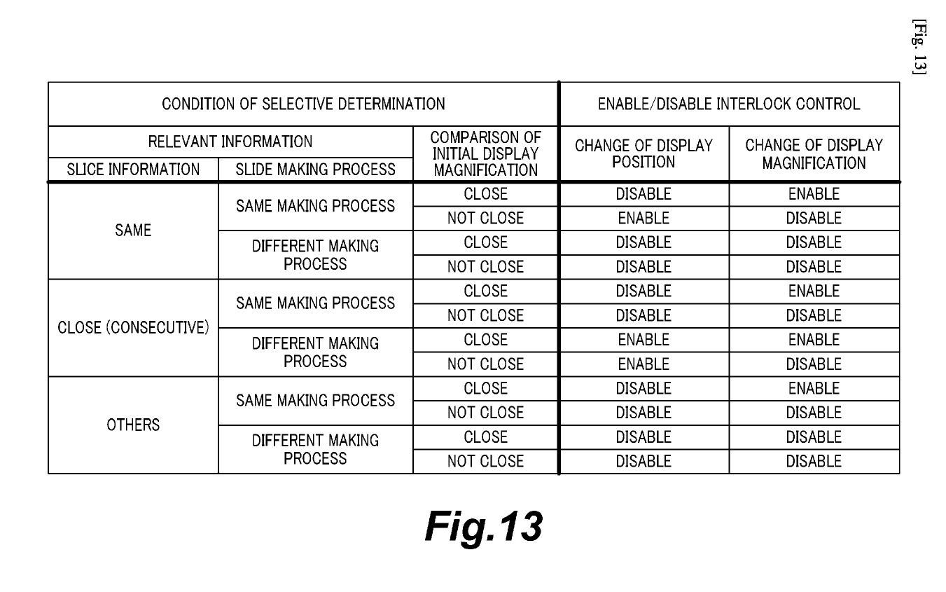

FIG. 13 shows the criteria for determination of the interlock control command in step S508 and the criteria for the determination in step S509 in this embodiment. In addition, FIG. 13 also shows the results of the determination as to whether or not the commands are to be applied in an interlocked manner. In the case shown in FIG. 13, the relevant information input in step S900 is slice information of the specimen captured in the image and information about the slide making process. Whether a command for changing the display state directed to one of images displayed side by side is to be applied in an interlocked manner to the display state of another image is controlled based on the aforementioned relevant information and the result of comparison of the initial display magnifications that was described in the first embodiment.

In the following description about FIG. 13, only conditions that are effective when an interlock control is enabled according to them will be described, and conditions according to which an interlock control is disabled will not be described in detail.

In FIG. 13, the “SAME” slice information means that displayed images are images of the same specimen, as described in the description about FIG. 10. Normally, if the specimen is the same, it may be considered that the slide making process is also the same. In the case where the relevant information is such, if the initial display magnifications of the images displayed side by side are close, it may be concluded that a reference image and an image of an object to be observed at a different site of the same specimen are compared at equal or close magnifications (as with the case shown in FIG. 7C in the second embodiment). In this case, a change of the display position is not applied in an interlocked manner, and a change of the display magnification is applied in an interlocked manner, as with the case where the slice information is “SAME” in FIG. 10 described in the second embodiment.

On the other hand, in the case where the slice information and the slide making process are both “SAME” and the display magnification is “NOT CLOSE” in FIG. 13, it may be concluded that the same site of the specimen is observed at different magnifications as with the case described in the first embodiment with reference to FIG. 7B. In this case, while a change of the display position is applied in an interlocked manner, a change of the display magnification is not applied in an interlocked manner, as with the case in which the display magnification is “NOT CLOSE” in FIG. 6 described in the first embodiment.

Next, the case where the slide making process is “SAME”, the display magnification is “CLOSE”, and the slice information is different, namely “CLOSE” or “OTHERS”, in FIG. 13 will be described. In the case where the same slide making process is used for specimens having different slice information, it is probable that an object is observed in comparison with a reference image having no relevancy in terms of the position in the image. Such observation may be considered to be the observation described above with reference to FIG. 7C (in which different sites of the same specimen are compared). Therefore, interlock control is performed in such a way that a change of the display position is not applied in an interlocked manner, and only a change of the display magnification is applied in an interlocked manner. This can facilitate efficiency of comparative observation of different sites of the same specimen, as with the case described with reference to FIG. 7C.

Next, the case where the slice information is “CLOSE”, the slide making process is “DIFFERENT”, and the display magnification is “CLOSE” in FIG. 13 will be described. As described before with reference to FIG. 3, if slides made by different processes are used, different features can be compared at the same display position by comparing picked-up images. As also described before with reference to FIG. 3, specimens having “close” slice information can be considered to show substantially the same cells. Moreover, if the display magnifications are close, it may be considered that the display magnifications are set close to each other in order to perform comparative observation of the images displayed side by side, even if the slides used to pick up the displayed images were made by different processes. Therefore, if a command for changing the display state is entered in this case, a change of the display position and a change of the display magnification are both applied in an interlocked manner as shown in FIG. 13 so that the same site of the specimen can be conveniently compared at the same magnification.

On the other hand, if the slice information is “CLOSE”, the slide making process is “DIFFERENT”, and the display magnification is “NOT CLOSE” in FIG. 13, it may be considered that comparative observation of different features in the same portion of a specimen is performed. Moreover, it may be considered that display magnifications that are suitable for the observation of the respective features are different from each other. Therefore, if a command for changing the display state is entered in this state, a change of the display position is applied in an interlocked manner, but a change of the display magnification is not applied in an interlocked manner as shown in FIG. 13 so that the features in the same portion of the specimen can conveniently observed at magnifications suitable respectively for them.

In the example shown in FIG. 13, neither a change of the display position nor a change of the display magnification is applied in an interlocked manner when any one of other conditions than the above described conditions is met. That is, if the slice information is “SAME” and the slide making process is “DIFFERENT” in FIG. 13, or, the slice information is “CLOSE”, the slide making process is “SAME”, and the display magnification is “NOT CLOSE” in FIG. 13, or, the slice information is “OTHERS”, the slide making process is “SAME”, and the display magnification is “NOT CLOSE” in FIG. 13, or, the slice information is “OTHERS” and the slide making process is “DIFFERENT” in FIG. 13, neither a change of the display position nor a change of the display magnification is applied in an interlocked manner.

As described above, interlock control of changes of the display position and changes of the display magnification are performed based on the combination of the initial display magnification and information relevant to the displayed images. Thus, interlock control can be performed in a manner suitable for the purpose of user's operation. In consequence, it is possible to further enhance user's operation efficiency in observation.

### Other Embodiments

The embodiments of the present invention are not limited to the first to third embodiments described in the foregoing, but there are various embodiments.

For example, while in the cases described with reference to FIGS. 10 and 13, the slice information is information about the position at which the specimen is sliced off from the sample to be examined, other information may be used as the slice information. For example, since the specimen has a thickness, though it is a thin sliced piece as shown in FIG. 3, a plurality of images can be obtained by imaging it consecutively while varying the focus position along the depth direction of the specimen perpendicular to the imaging surface. In such images, information about the imaging position (focus position) with respect to the depth direction (or thickness direction), which will be hereinafter referred to as the depth information, may be used as the slice information. An example of the situation in which the depth information can be preferably used as the slice information in performing interlock control of a command for changing the display state is found in observation of slides for cell diagnosis described in the description of the second embodiment. Some slides for cell diagnosis contain a specimen in which uncut cells are arranged one above another in the thickness direction of the slides. It is sometimes difficult to pick up an image in which both the cells arranged one above the other are in-focus using an ordinary objective lens of a microscope due to a small depth of field. In consequence, it is difficult to observe the cells arranged one above the other in a single image at the same time, and it is difficult in some cases to perform the observation described above with reference to FIG. 7C while observing a cell at a different position with respect to the thickness direction in comparison. In such cases, it is preferred to pick up images of the same slide while varying the position with respect to the thickness direction to obtain image data. In the case where a plurality of images based on such image data are observed side by side, it is preferred that the depth information be used instead of the slice information, and that the interlock control same as that in the case where the slice information is “CLOSE”, the slide making process is “SAME”, and the display magnifications are “CLOSE” in FIG. 13 be performed. In this case, interlock control is performed in such a way that a change of the display position is not applied in an interlocked manner, and only a change of the display magnification is applied in an interlocked manner as shown in FIG. 13. Then, different portions (with respect to the thickness direction) of the same specimen can be observed in comparison with each other efficiently as described before with reference to FIG. 7C. In the case where the depth information is the same (namely, if images have the same depth information), it may be considered that the images are at the same position with respect to the thickness direction. In this case, it is preferred that the interlock control same as that in the case where the slide information is “SAME” in FIG. 13 be performed. In the case where the depth information is not the same (including the case where the depth information is absent), the slide making process is the “same”, and the display magnifications are “close”, it may be considered that comparison with a reference image is performed. In the case where the depth information is not the same, and the slide making process is not the “SAME” or the display magnifications are “NOT CLOSE”, it may be considered that images having no relevancy are displayed side by side. Then, the interlock control same as that in the case where the slice information is “OTHERS” in FIG. 13 be performed.

While in the above-described embodiments, displayed images are images obtained by imaging a slide(s) using a microscope, the present invention can also be applied to images obtained using other apparatuses.

For example, three-dimensional images can be picked up using a CT (Computed Tomography) or MRI (Magnetic Resonance Imaging) apparatus or the like. These imaging apparatuses can image a relatively large object such as a human body without physically cutting it to provide an image of a desired cross section. When images picked up using such an apparatus are observed, for example, cross sectional images of a human body picked up in a plurality of parallel planes in the horizontal and vertical directions are prepared and observed in some cases. For example, a plurality of parallel cross sectional images in the respective directions may be observed in comparison with each other. Alternatively, cross sectional images of the horizontal and vertical directions may be displayed and observed side by side in comparison with each other. In such observation, for example, an image picked up at some position that shows the state of an affected part best is selected from among the images picked up in the plurality of cross sectional planes parallel to the vertical direction at different positions. In this case, the magnification suitable for the observation of a characteristic feature of the affected part is not necessarily always the same but may vary depending on the state of the affected part and/or other factors. Therefore, it may be sometimes preferred that a plurality of images be observed in comparison with each other while varying the magnification. Moreover, since the number of affected parts to be carefully examined in the image is not necessarily one, it may be sometimes preferred that images of different affected parts be observed in comparison while changing the display position. After one image most suitable for observation has been selected, a portion to be carefully examined may be selected from the entire image and enlarged for observation. In this case, images of display magnifications not close to each other, e.g. the entire image and the enlarged image, may be displayed side by side, whereby the extent of the affected area and details of the affected state can both be observed. Thus, efficiency in diagnosis can be enhanced.

On the other hand, there may be cases where a plurality of images of an affected part picked up on cross sections of different orientations such as a horizontal cross section and a vertical cross section are observed in comparison with each other. In particular, when cross sections perpendicular to each other are observed, it is sometimes desirable that magnifications suitable for observation of a feature in the respective images be made equal to each other to allow observation thereof in comparison with each other, because the object to be examined is the same, although there is no positional relevancy between the two cross sections. Moreover, different imaging methods such as CT and MRI have different objects that can be imaged with them. Therefore, the method of observation will vary according to whether the imaging method used in obtaining the images are the same or different. Specifically, if the imaging methods used to pick up images are different, it may be considered that the same portion of an affected area is observed in the images by different methods in comparison with each other.

In the above-described cases, it is preferred that the present invention be applied in the following way.

In the above-described embodiments, the switching conditions concerning the slice information, slide making process, and the initial display magnification described in FIGS. 6, 10, 11, and 13 are assumed to be applied to cases where microscope image of slides made by slicing the paraffin block 300 shown in FIG. 3 are observed. In the case of images picked up by using a CT or MRI apparatus or the like, the conditions concerning the initial display magnification in FIGS. 6 and 13 can be applied to such images without modifications. For example, in the case where conditions in FIG. 6 are applied, if the display magnifications of images displayed side by side are close, it may be considered that the state of an object is observed at the same display position and at the same magnification, as with the case described before with reference to FIG. 6. Then, a change in the display position and a change of the display magnification are both applied in an interlocked manner. On the other hand, if the display magnifications are not close, it may be considered that an object is observed at the same display position and at different display magnifications that are not close to each other. Then, only a change of the display position is applied in an interlocked manner.

In the case where the conditions in FIG. 10 are applied, it is preferred that whether or not the images observed in comparison with each other are images of cross sections parallel to each other be set as a switching condition instead of the slice information. Specifically, when generating images to be displayed from the result of imaging obtained as three-dimensional image, the position and the orientation of the cross section of the image are stored and used in the determination. As described above, if images of parallel cross sections are observed in comparison with each other, it may be considered that the observation is performed to find a cross section that shows an affected part best. Then, it is preferred that a change of the display position and a change of the display magnification are both applied in an interlocked manner. On the other hand, if images of cross sections not parallel to each other are observed, the display positions in the respective images be shifted independently from each other, because the images in different orientations have low positional relevancy with each other. On the other hand, when images of the same affected part are observed, it is desirable that the images be displayed at the same display magnification. Then, it is preferred that only the magnification be changed in an interlocked manner. Therefore, it is preferred that the condition in the case where the slice information is “CLOSE” in FIG. 10 be applied to the case where the cross sections are parallel, and the condition in the case where the slice information is “SAME” in FIG. 10 be applied to the case where the cross sections are not parallel. Furthermore, in other cases such as cases where information about the cross sections cannot be obtained, it may be considered that images having no relevancy with each other are displayed side by side. Then, it is preferred that the condition in the case where the slice information is “OTHERS” in FIG. 10 be applied.

Furthermore, the imaging method may be used as a condition instead of the slide making process in FIG. 11. Specifically, as described above in the case where different features are observed in comparison with each other using images obtained by different imaging methods, it is preferred that the display position and the display magnification be both changed in an interlocked manner, namely the condition of different making processes in FIG. 11 be replaced by the condition that different imaging methods are used. on the other hand, images obtained by the same imaging method are used, it may be considered that an image having low relevancy in terms of the display position in the image is observed in comparison with a reference image. Then, it is preferred that the condition of the same making process in FIG. 11 be replaced by the condition that the same imaging method is used.

The replacement of the switching conditions may also be applied to FIG. 13. In FIG. 13, the slice information may be replaced by information about whether or not images of parallel cross sections are observed in comparison with each other as with the above-described case, and the slide making process be replaced by information about the imaging method as the object-related information.

The imaging methods may include microscopy in addition to the CT and MRI. If the imaging method is microscopy, any one of FIGS. 6, 10, 11, and 13 may further be applied.

If the imaging method can be identified from the type of the object, the type of the object may be referred to instead of the imaging method. Specifically, if the object is a slide, it can be concluded that the imaging apparatus was a microscope, and if the object is a human body, it may be concluded that the imaging apparatus is a CT apparatus or a MRI apparatus. Moreover, if the object is a slide, the conditions may be switched taking into consideration the slide making process also. For example, the conditions to be applied may be changed according to the purpose of the slide such as tissue diagnosis or cell diagnosis, and one of the slice information and the depth information may be selectively used. To sum up, conditions suitable for the imaging method or the object may be applied.

While it has been described that the embodiments described in the foregoing are implemented in a program executed by the CPU 200, the implementation of the present invention is not limited to this. For example, a part or all of the above-described process may be implemented in hardware.

The present invention is not limited to the process executed in the terminal 107 to which the display 108 is connected, but drawing data may be generated by another terminal connected through a network. Then, an image may be displayed on the display 108 using drawing data transmitted through the network. Thus, the present invention can also be applied to a system configured in such a way that a terminal in which drawing data is generated and a display on which image display is performed are located remote from each other.

As described in the foregoing, according to the present invention, it is possible to selectively determine whether a shift of the display position or a change of the display magnification are to be applied in an interlocked manner to images displayed side by side according to at least one of information determined at the time of obtaining the images, information concerning the image drawing, and the display magnifications. In consequence, it is possible to reduce the user's effort in selecting images to which an interlock control of display action is to be performed, thereby improving operation efficiency in image observation. Furthermore, whether two types of command, that is, shifting of the display position and changing of the display magnification, are to be controlled in an interlocked manner or not is determined automatically according to some conditions. Therefore, the selective determination as to whether or not interlock control is to be performed can be made taking into account combinations more complex than those in the case where only one of interlock control of a shift of the display position and interlock control of a change of the display magnification is automatically determined. In consequence, operation efficiency in observation can be improved. Moreover, in the embodiments, switching between interlock control of only a shift of the display position, only a change of the display magnification, and the both can be performed according to conditions in a manner more complex than in the case where interlock control of a shift of the display position and a change of the display magnification is determined simultaneously in an all-or-none manner for the both. In consequence, operation efficiency in observation can further be improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283251, filed on Dec. 26, 2011, which is hereby incorporated by reference herein in its entirety.

1. A control method for a display data generating apparatus comprising:
an image data obtaining step of obtaining image data of one or a plurality of images obtained by imaging an object;
a display data generating step of generating display data configured in such a way that images are displayed in a plurality of display regions side by side based on the image data;
a command obtaining step of obtaining a changing command, input by a user and directed to any one of the plurality of display regions, for changing the display state, including scrolling or changing the display magnification, of an image displayed in that displayed region;
an interlock control enabling/disabling determination step of determining whether or not each of the display regions other than a command target display region defined as the display region to which the command for changing the display state is directed is set as an interlock control target display region in which a change of the display state according to the changing command is to be applied to an image displayed therein simultaneously with the change of the display state made to the image displayed in the command target display region; and
a display state changing step of applying the change of the display state according to the changing command to the image displayed in the command target display region and simultaneously applying the change of the display state according to the changing command to the image displayed in the interlock control target display region,
wherein the interlock control enabling/disabling determination step determines whether or not each display region is set as the interlock control target display region based on the display magnification of the image displayed in each display region at the time when the changing command is obtained.

2-6. (canceled)

7. A non-transitory computer readable storage medium storing a computer program that causes a computer to executes the following steps:
an image data obtaining step of obtaining image data of one or a plurality of images obtained by imaging an object;
a display data generating step of generating display data configured in such a way that images are displayed in a plurality of display regions side by side based on the image data;
a command obtaining step of obtaining a changing command, input by a user and directed to any one of the plurality of display regions, for changing the display state, including scrolling or changing the display magnification, of an image displayed in that displayed region;
an interlock control enabling/disabling determination step of determining whether or not each of the display regions other than a command target display region defined as the display region to which the command for changing the display state is directed is set as an interlock control target display region in which a change of the display state according to the changing command is to be applied to an image displayed therein in an interlocked manner with the change of the display state made to the image displayed in the command target display region; and
a display state changing step of applying the change of the display state according to the changing command to the image displayed in the command target display region and applying, in an interlocked manner, the change of the display state according to the changing command to the image displayed in the interlock control target display region,
wherein in the interlock control enabling/disabling determination step, it is determined whether or not each display region is set as the interlock control target display region based on the display magnification of the image displayed in each display region at the time when the changing command is obtained.

8. A display data generating apparatus comprising:
an image data obtaining unit configured to obtain image data of one or a plurality of images obtained by imaging an object;
a display data generating unit configured to generate display data configured in such a way that images are displayed in a plurality of display regions side by side based on the image data;
a command obtaining unit configured to obtain a changing command, input by a user and directed to any one of the plurality of display regions, for changing the display state, including scrolling or changing the display magnification, of an image displayed in that displayed region;
an interlock control enabling/disabling determination unit configured to determine whether or not each of the display regions other than a command target display region defined as the display region to which the command for changing the display state is directed is set as an interlock control target display region in which a change of the display state according to the changing command is to be applied to an image displayed therein in an interlocked manner with the change of the display state made to the image displayed in the command target display region; and
a display state changing unit configured to apply the change of the display state according to the changing command to the image displayed in the command target display region and to apply, in an interlocked manner, the change of the display state according to the changing command to the image displayed in the interlock control target display region,
wherein the interlock control enabling/disabling determination unit determines whether or not each display region is set as the interlock control target display region based on the display magnification of the image displayed in each display region at the time when the changing command is obtained.

9. The control method for the display data generating apparatus according to claim 1, wherein in the interlock control enabling/disabling determination step, such a display region is set as the interlock control target display region that the display magnification of the image displayed therein and the display magnification of the image displayed in the command target display region are equal or a difference between them is smaller than a threshold value.

10. The control method for display the data generating apparatus according to claim 1, wherein in the interlock control enabling/disabling determination step, whether or not each display region is set as the interlock control target display region is determined further based on at least one of information about the object of the image displayed in each display region and information about the image data of the image displayed in each display region.

11. The control method for the display data generating apparatus according to claim 10, wherein
the object is a slide on which a specimen cut off from a sample to be examined is placed,
the information about the object includes information about the position at which the specimen was cut off from the sample to be examined and information about a process of making the slide,
in the interlock control enabling/disabling determination step, a determination target display region is determined as the interlock control target display region when
the position information of the image displayed in the determination target display region and the position information of the image displayed in the command target display region are equal to each other,
the process of making the slide of the image displayed in the determination target display region and the process of making the slide of the image displayed in the command target display region are equal to each other, and
the display magnification of the image displayed in the determination target display region and the display magnification of the image displayed in the command target display region are equal to each other or the difference between them is smaller than a threshold value; and
in the display state changing step, scrolling is not applied to the image displayed in the interlock control target display region in an interlocked manner and changing the display magnification is applied to the image displayed in the interlock control target display region in an interlocked manner.

12. The control method for the display data generating apparatus according to claim 10, wherein
the object is a slide on which a specimen cut off from a sample to be examined is placed,
the information about the object includes information about the position at which the specimen was cut off from the sample to be examined and information about a process of making the slide,
in the interlock control enabling/disabling determination step, a determination target display region is determined as the interlock control target display region when
the position information of the image displayed in the determination target display region and the position information of the image displayed in the command target display region are equal to each other,
the process of making the slide of the image displayed in the determination target display region and the process of making the slide of the image displayed in the command target display region are equal to each other, and
the display magnification of the image displayed in the determination target display region and the display magnification of the image displayed in the command target display region are not close to each other or the difference between them is smaller than a threshold value; and
in the display state changing step, scrolling is applied to the image displayed in the interlock control target display region in an interlocked manner and changing the display magnification is not applied to the image displayed in the interlock control target display region in an interlocked manner.

13. The control method for the display data generating apparatus according to claim 10, wherein
the object is a slide on which a specimen cut off from a sample to be examined is placed,
the information about the object includes information about the position at which the specimen was cut off from the sample to be examined and information about a process of making the slide,
in the interlock control enabling/disabling determination step, a determination target display region is determined as the interlock control target display region when
the position information of the image displayed in the determination target display region and the position information of the image displayed in the command target display region are close to each other,
the process of making the slide of the image displayed in the determination target display region and the process of making the slide of the image displayed in the command target display region are different from each other, and
the display magnification of the image displayed in the determination target display region and the display magnification of the image displayed in the command target display region are equal to each other or the difference between them is smaller than a threshold value; and
in the display state changing step, scrolling is applied to the image displayed in the interlock control target display region in an interlocked manner and changing the display magnification is applied to the image displayed in the interlock control target display region in an interlocked manner.
